(19) United States
(12) Patent Application Publication
(10) Pub. No.: US 2022/0119134 A1
(43) Pub. Date: Apr. 21, 2022

(54) PAYLOAD MOUNTING METHOD, SYSTEM, AND APPARATUS

(71) Applicant: OMNITEQ, LLC, Houston, TX (US)

(72) Inventor: Michael David Johnson, Houston, TX (US)

(21) Appl. No.: 17/493,568

(22) Filed: Oct. 4, 2021

Related U.S. Application Data
(60) Provisional application No. 63/094,702, filed on Oct. 21, 2020.

(51) Int. Cl. B64G 1/64

(52) U.S. Cl. CPC B64G 1/641; B64G 1/645

(57) ABSTRACT

A payload mounting system including a launch vehicle attach structure with radial ports, payloads, and a moment transmitting structure. The payloads attach to the radial ports. The moment transmitting structure attaches to the payloads surrounding said launch vehicle attach structure to minimize the moment transmitted to the radial ports thus maximizing the launch mass capability of the launch vehicle attach structure. The payload mounting system presents a novel evolved expendable launch vehicle (EELV) secondary payload adapter (ESPA) port small payload mounting system that permits maximum mass utilization of each ESPA ports without regard to center of gravity constraints. In one or more embodiments, the payload mounting system enables to connect, in the unused central volume of an ESPA ring, the adjacent faces of at least two payloads on opposing sides of an ESPA ring with a cross-reaching moment transmitting structure that reduces moments transmitted to the ESPA ring.

### CROSS-REFERENCE TO RELATED APPLICATIONS

The present application claims priority from U.S. Provisional Patent Application Ser. No. 63/094,702, filed on Oct. 21, 2020, which is incorporated herein by its entirety and referenced thereto.

### FIELD OF THE DISCLOSURE

This disclosure relates generally to a novel Evolved Expendable Launch Vehicle (EELV) Secondary Payload Adapter (ESPA) port small payload mounting system that permits maximum mass utilization of each ESPA port without regard to center of gravity constraints. In one or more embodiments, the apparatus and method include connecting, in the unused central volume of an ESPA ring, the adjacent faces of at least two payloads on opposing sides of an ESPA ring with a cross-reaching moment transmitting structure that reduces moments transmitted to the ESPA ring.

### BACKGROUND OF THE DISCLOSURE

For the purposes of interpreting the disclosure made herein the terms “payload” and “satellite”, or derivations thereof, are used interchangeably and should be considered synonymous. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

An ESPA ring can be generally defined as a device that permits a single launch vehicle to carry a multiple number of individual payloads by mounting one or more cylindrical shaped ESPA rings on the top of the last stage of a launch vehicle and then attaching one or more payloads radially on each ESPA port. Many ESPA ports reside on the outside diameter of each the ESPA ring cylindrical structure and may contain multiple payloads that fit between the outer diameter of the ESPA ring and the inside diameter of the fairing of a launch vehicle. In some cases, one or more ESPA rings are located under a primary payload, where the primary payload is mounted on a traditional axial mounting structure on the top of the uppermost ESPA ring. In some cases, one or more ESPA rings are utilized to carry multiple satellites on a single launch vehicle without carrying a traditional axial mounted payload on the top of the uppermost ESPA ring. An example of such a compliment is used on SpaceX Rideshare missions.

The ESPA ring has provided many more launch opportunities for smaller payloads since its introduction but it has a serious flaw. The radial cantilevered mounting of the payloads on the ESPA mounting ports generates a tremendous moment on the ESPA ring when the launch vehicle is experiencing the largest acceleration load along the axial direction of the launch vehicle. The maximum moment imposed on the ESPA port is the product of the axial acceleration of the launch vehicle multiplied by the mass of the payload further multiplied by the distance of the center of gravity from the plane of the ESPA port. The maximum mass that can be tolerated by each ESPA port is reduced as the center of gravity distance of the payload is increased from the plane of the ESPA port.

In most cases, the available volume of a payload between the outer diameter of the ESPA ring and the inner diameter of the launch vehicle fairing determines a standard size of payload, generally this payload volume is called an “ESPA class” payload. In most cases, designing a payload with an offset center of gravity is not practical and as such, the center of gravity is generally located at approximately 50% of the radial length of the payload from the ESPA port plane. For example, in the case of a 24 inch diameter ESPA port on a SpaceX Rideshare mission this has the effect of reducing the maximum mass carrying capacity of an ESPA ring for the maximum CG distance (102 cm) from the ESPA port plane by a factor of (840 kg/250 kg) 3.36×. In fact, the maximum mass (800 kg) can only be accommodated with a center of gravity at 26 cm. This would generally limit the height of a maximum mass payload to only 52 cm. This is generally not practical.

To elaborate further on this problem, the volume available for payloads on an ESPA ring between the outer diameter of the ESPA ring and the inner diameter of the launch vehicle fairing increases in the radial direction as the ESPA payload volumes are generally “pie” shaped. Thus, there is more available volume for satellites at a distance farther away from the ESPA port plane which, as stated earlier, tends to reduce the available launch mass capability due to the large moment arm imposed on the ESPA port by the payload.

Additionally, the volume on the inside diameter of an ESPA ring is generally unused since the payloads are mounted on the outer diameter faces of the ESPA ring.

The disclosed subject matter helps to avoid these and other problems in a new and novel way.

### SUMMARY OF THE DISCLOSURE

This disclosure relates generally to a novel Evolved Expendable Launch Vehicle (EELV) Secondary Payload Adapter (ESPA) port small payload mounting system that permits maximum mass utilization of each ESPA port without regard to center of gravity constraints. In one or more embodiments, the apparatus and method include connecting, in the unused central volume of an ESPA ring, the adjacent faces of at least two payloads on opposing sides of an ESPA ring with a cross-reaching moment transmitting structure that reduces moments transmitted to the ESPA ring.

A second disclosure relates to an alternate method of transmitting moments to a larger diameter cylindrical structure with its long axis oriented parallel and concentric with the launch vehicle and ESPA ring which lies between the ESPA ring and the fairing of the launch vehicle and is attached to the payloads surrounding the ESPA ring which distributes moments transmitted to the ESPA ring.

A third disclosure combines the two previous disclosures to ensure efficient load transfer to the ESPA ring.

According to the teachings of the present disclosures, there is here provided an ESPA payload mounting system that utilizes 1. a cross-reaching moment transmitting structure that connects adjacent faces of ESPA payloads on opposing sides of an ESPA ring or, 2. a larger diameter cylindrical structure with its long axis oriented parallel and concentric with the launch vehicle and ESPA ring which lies between the ESPA ring and the fairing of the launch vehicle and is attached to the payloads or, 3. A combination of the previous two methods.

In all the embodiments, for the payloads to separate and deploy from the ESPA ring after arrival of the launch vehicle to the deployment destination, the payloads are attached to their respective ESPA ports by well-known separation systems. This is easily accomplished by utilizing any well-known separation system known in the prior art (e.g. a separation nut, pyrotechnic nut, Marmon clamp, etc.) that fastens the payload to the ESPA port.

The moment transmitting structure must also permit the payloads to separate from the ESPA ring and from each other while still transmitting moments between the payloads while the moment transmitting structure is still connected (in the case of the cross-reaching moment transmitting structure) to the opposing located or (in the case of the outer cylindrical moment transmitting structure) to the adjacent payloads. This is also accomplished by utilizing any well-known separation system known in the prior art (e.g. a separation nut, pyrotechnic nut, Marmon clamp, etc.) that fastens the moment transmitting structure to the payload(s).

In the first and third embodiments the cross-reaching moment transmitting structure should be sized such that the outer diameter of the cross-reaching moment transmitting structure readily fits through the inner diameter of the ESPA port hole that pierces the ESPA ring. This permits the moment transmitting structure (if desired) to be ejected with the payload. As such, this normally unused volume in an ESPA ring can be utilized for additional extremely valuable payload volume. It should be noted that the moment transmitting structure could remain behind with the ESPA ring after the payload deployment event if desired.

In the second and third embodiments the larger diameter moment transmitting cylindrical structure generally should be sized such that the outer diameter of the moment transmitting cylindrical structure forms the base mounting diameter of the payloads. This provides the maximum bracing advantage to the payloads and contributes to efficient distribution of moments throughout the structure.

The main advantages of using the inventive mounting system is that it maximizes the mass utilization of each ESPA port without imposing the previously stated onerous center of gravity location constraints on the payloads.

Descriptions of certain illustrative aspects are described herein in connection with the figures. These aspects are indicative of various non-limiting ways in which the disclosed subject matter may be utilized, all of which are intended to be within the scope of the disclosed subject matter.

Other advantages, emerging properties, and features will become apparent from the following detailed disclosure when considered in conjunction with the associated figures that are also within the scope of the disclosure.

### BRIEF DESCRIPTION OF THE DRAWINGS

The present subject matter will now be described in detail with reference to the drawings, which are provided as illustrative examples of the subject matter to enable those skilled in the art to practice the subject matter. Notably, the figures and examples are not meant to limit the scope of the present subject matter to a single embodiment, but other embodiments are possible by way of interchange of some or all of the described or illustrated elements and, further, wherein:

FIG. 1 illustrates a prior art ESPA ring and associated payload volume;

FIG. 2 illustrates a prior art graph showing the relationship of ESPA port maximum mass capability versus center of gravity location;

FIG. 3A illustrates the first embodiment of the inventive device showing the cross-reaching moment transmitting embodiment;

FIG. 3B illustrates the first embodiment of the inventive device showing the cross-reaching moment transmitting embodiment after deployment;

FIG. 4 illustrates the central cross-reaching moment transmitting separation system utilized in the first embodiment;

FIG. 5A illustrates the second embodiment of the inventive device showing the larger diameter moment transmitting cylindrical structure embodiment;

FIG. 5B illustrates the second embodiment of the inventive device showing the larger diameter moment transmitting cylindrical structure embodiment after deployment;

FIG. 6A illustrates the third embodiment of the inventive device combining the first two embodiments;

FIG. 6B illustrates the third embodiment of the inventive device combining the first two embodiments after deployment.

### DETAILED DESCRIPTION OF ILLUSTRATIVE EMBODIMENTS

The detailed description set forth below in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form to avoid obscuring the concepts of the presently disclosed method and system.

In the present specification, an embodiment showing a singular component should not be considered limiting. Rather, the subject matter preferably encompasses other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present subject matter encompasses present and future known equivalents to the known components referred to herein by way of illustration.

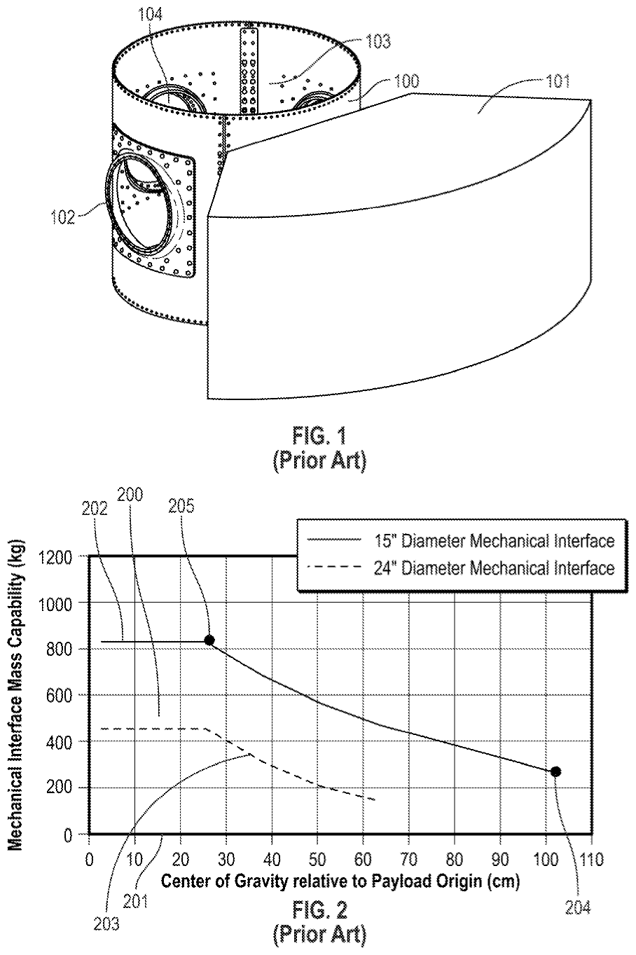

The figures herein provided, in conjunction with the written description here, clearly provide enablement of all claimed aspects of the disclosed subject matter. Accordingly, in FIG. 1 a prior art single ESPA ring 100 and associated payload volume 101 are illustrated, in this example for a SpaceX Rideshare mission 24-inch port. There are four pie shaped volumes 101 available for each of four radially mounted payloads. ESPA port attach structure 102 (or launch vehicle attach structure) utilizes bolts to attach well-known payload separation systems that are in turn attached to the payloads permitting payload separation when desired. Cross-reaching volume 103 is generally not utilized and is empty with clear access to all ESPA port apertures 104.

FIG. 2 is a graph showing the relationship of the mass (ordinate axis) 200 with the center of gravity location (abscissa axis) 201 for a SpaceX 24-inch ESPA port 202 and a SpaceX 15-inch ESPA port 203. For example, in the case of a 24-inch diameter ESPA port 202 on a SpaceX Rideshare mission this has the effect of reducing the maximum mass carrying capacity of an ESPA ring for the maximum CG distance (102 cm) 204 from the ESPA port plane by a factor of (840 kg/250 kg) 3.36×. In fact, the maximum mass (800 kg) can only be accommodated with a center of gravity at 26 cm 205. This would generally limit the height of a maximum mass payload to only 52 cm. This is generally not practical.

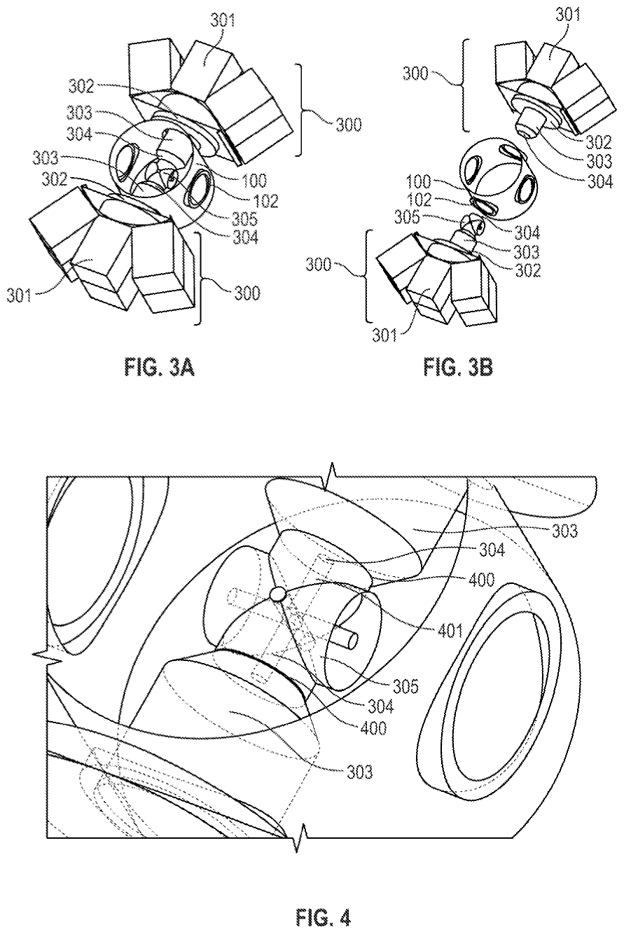

FIGS. 3A (pre-deployed configuration) and 3B (post deployed configuration) illustrate the first embodiment of the inventive device showing the cross-reaching moment transmitting embodiment. Payload assembly 300 (or payloads) contains sub-payloads 301. Payload assemblies 300 mount on ESPA port attach structure 102 (attached to ESPA ring 100) utilizing bolts to attach well-known payload separation systems 302 (or a first payload separation system) that are in turn attached to payload assemblies 300 permitting payload assembly 300 separation when desired. Moment transmitting structure 303 is attached to payload assembly 300. An additional separation system (or second separation system, e.g. a separation nut and bolt) 304 attaches moment transmitting structure 303 to a central coupling device 305. The assemblies 303, 304 and 305, when fastened together, transmit loads and moments across the diameter of ESPA ring 100, thus relieving the moment loading on ESPA port attachment 102 and accomplishing the objective of reducing the moment applied to ESPA port attachment 102 to maximize the mass carrying capability of ESPA ring 100. FIGS. 3A and 3B illustrate two payload assemblies 300 but any even number of payload assemblies 300 may be accommodated so long as they are located at opposing ESPA port attachment 102 locations on ESPA ring 100.

Deployment of the payload assemblies 300 occurs when separation systems 302 and 304 release the payload assemblies 300 and they may be radially ejected from ESPA ring 100 using well known means (e.g. separation springs). Note that central coupling device 305 remains attached to one of the payload assemblies 300 to prevent generation of additional space debris. It is also important that the diameters of moment transmitting structures 303 and central coupling device 305 are less than the diameter of ESPA port aperture 104 to permit ejection of the payload assemblies 100. It is also evident that moment transmitting structures 303 can be used for additional payload assembly 300 volume utilization.

FIG. 4 illustrates a four-way central cross-reaching moment transmitting separation system 305 utilized in the first embodiment where payload assembly 300 is attached to moment transmitting structure 303 that has a conical end whose lesser diameter contacts edge 400. A separation device 304 is attached to tension structure 401. In this way, by tensioning member 401 via the separation devices 304, compression, and moments will be transmitted via edge 400 and tension loads via member 401 while the separation devices remain attached. Upon separation of separation devices 304, all the payload assemblies 300 are free to separate. As stated earlier, central coupling device 305 may remain attached to one of the payload assemblies 300 to prevent generation of additional space debris or it may be left behind with ESPA ring 100 by tethering central coupling device 305 to ESPA ring 100 using any well known means.

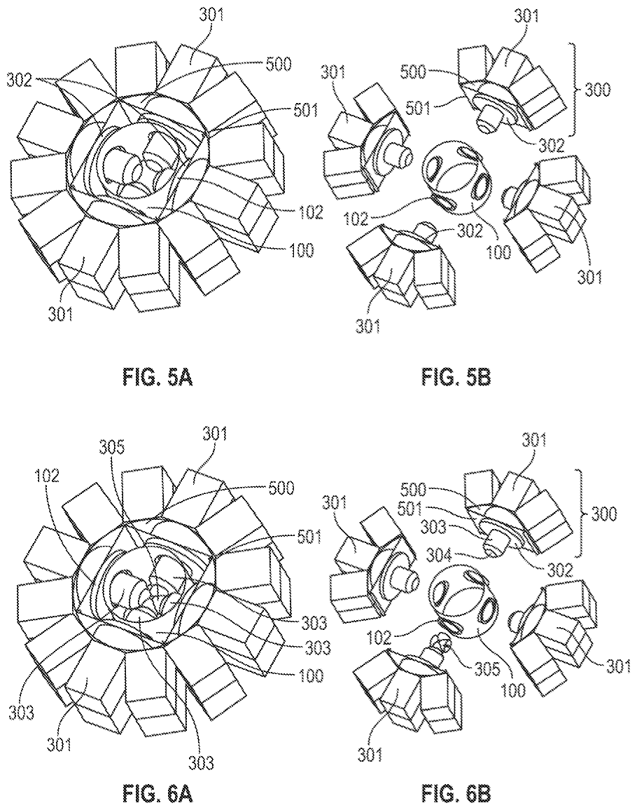

FIGS. 5A (pre-deployed configuration) and 5B (post deployed configuration) illustrate the second embodiment of the inventive device showing the larger diameter moment transmitting cylindrical structure embodiment. Payload assembly 300 contains sub-payloads 301. Payload assemblies 300 mount on ESPA port attach structure 102 (attached to ESPA ring 100) utilizing bolts to attach well-known payload separation systems 302 that are in turn attached to payload assemblies 300 permitting payload assembly 300 separation when desired. Moment transmitting structure 500 is attached to payload assembly 300. An additional separation system (or a third separation system, e.g. a separation nut and bolt) 501 attaches moment transmitting structure 500 to adjacent payload assembly moment transmitting structure 500. The assemblies 500, when fastened together, transmit loads and moments to the other assemblies 500, thus relieving the moment loading on ESPA port attachments 102 and accomplishing the objective of reducing the moment applied to ESPA port attachment 102 to maximize the mass carrying capability of ESPA ring 100. FIGS. 5A and 5B illustrate four payload assemblies 300 but any number of payload assemblies 300 may be accommodated so long as they are surrounding ESPA ring 100.

Deployment of the payload assemblies 300 occurs when separation systems 302 and 501 release the payload assemblies 300 and they may be radially ejected from ESPA ring 100 using well known means (e.g. separation springs). It is also evident that moment transmitting structures 500 can be used for additional payload assembly 300 volume utilization.

FIGS. 6A (pre-deployed configuration) and 6B (post deployed configuration) illustrate the third embodiment of the inventive device combining the cross-reaching moment transmitting embodiment with the larger diameter moment transmitting cylindrical structure embodiment. Payload assembly 300 contains sub-payloads 301. Payload assemblies 300 mount on ESPA port attach structure 102 (attached to ESPA ring 100) utilizing bolts to attach well-known payload separation systems 302 that are in turn attached to payload assemblies 300 permitting payload assembly 300 separation when desired. Moment transmitting structure 303 is attached to payload assembly 300. An additional separation system (e.g. a separation nut and bolt) 304 attaches moment transmitting structure 303 to a central coupling device 305. The assemblies 303, 304 and 305, when fastened together, transmit loads and moments across the diameter of ESPA ring 100, thus relieving the moment loading on ESPA port attachment 102 and accomplishing the objective of reducing the moment applied to ESPA port attachment 102 to maximize the mass carrying capability of ESPA ring 100. Additional moment transmitting structure 500 is attached to payload assembly 300. An additional separation system (e.g. a separation nut and bolt) 501 attaches moment transmitting structure 500 to adjacent payload assembly moment transmitting structure 500. The assemblies 500, when fastened together, transmit loads and moments to the other assemblies 500, thus further relieving the moment loading on ESPA port attachments 102 and accomplishing the objective of reducing the moment applied to ESPA port attachment 102 to maximize the mass carrying capability of ESPA ring 100. FIGS. 6A and 6B illustrate four payload assemblies 300 but any number of payload assemblies 300 may be accommodated so long as they are even numbered and surround ESPA ring 100.

Deployment of the payload assemblies 300 occurs when separation systems 302, 304 and 501 release the payload assemblies 300 and they may be radially ejected from ESPA ring 100 using well known means (e.g. separation springs). It is also evident that moment transmitting structures 303 and 500 can be used for additional payload assembly 300 volume utilization.

In summary, here has been shown an ESPA payload mounting system that utilizes 1. a cross-reaching moment transmitting structure 303 that connects adjacent faces of ESPA payloads 300 on opposing sides of ESPA ring 100 or, 2. a larger diameter cylindrical structure 500 with its long axis oriented parallel and concentric with the launch vehicle and ESPA ring 100 which lies between ESPA ring 100 and the fairing of the launch vehicle and is attached to the payloads 300 or, 3. A combination of the previous two methods that accomplishes the goal of maximum mass utilization of each ESPA port without regard to center of gravity constraints.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The detailed description set forth here, in connection with the appended drawings, is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments.

This detailed description of illustrative embodiments includes specific details for providing a thorough understanding of the presently disclosed subject matter. However, it will be apparent to those skilled in the art that the presently disclosed subject matter may be practiced without these specific details. In some instances, well-known structures and devices are shown in block diagram form in order to avoid obscuring the concepts of the presently disclosed method and system.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein, but is to be accorded the widest scope consistent with the principles and novel features disclosed herein. It is contemplated that additional embodiments are within the spirit and true scope of the disclosed subject matter.

What is claimed is:

1. A payload mounting system, comprising:
a launch vehicle attach structure comprising radial ports;
payloads, wherein said payloads attach to said radial ports; and
a moment transmitting structure,
wherein said moment transmitting structure attaches to said payloads surrounding said launch vehicle attach structure to minimize the moment transmitted to said radial ports thus maximizing the launch mass capability of said launch vehicle attach structure.

2. The payload mounting system of claim 1, wherein said launch vehicle attach structure has a cylindrical structure.

3. The payload mounting system of claim 1, wherein said radial ports come in an even number.

4. The payload mounting system of claim 3, wherein said payloads ports come in an even number corresponding to said radial ports.

5. The payload mounting system of claim 1, wherein said moment transmitting structure has a cylindrical structure.

6. The payload mounting system of claim 1, wherein said launch vehicle attach structure positions at an expendable launch vehicle (EELV) secondary payload adapter (ESPA) ring.

7. The payload mounting system of claim 1, wherein each payload of said payloads attaches to a radial port of said radial ports via a first payload separation system, wherein said first payload separation system permits separation of said payload from said launch vehicle attach structure.

8. The payload mounting system of claim 1, further comprises a second separation device, wherein second separation device attaches said moment transmitting structure to a central coupling device.

9. The payload mounting system of claim 7, wherein said moment transmitting structure comprises a third separation system that acts as an additional separation system to connect said payload.

10. The payload mounting system of claim 9, wherein said first payload separation system and said third separation system engage to release and eject said payloads radially from said launch vehicle attach structure.

11. The payload mounting system of claim 8, wherein said payloads, said second separation device, and said central coupling device transmit loads and moments across the diameter of said launch vehicle attach structure positioned at an expendable launch vehicle (EELV) secondary payload adapter (ESPA) ring, thus relieving the moment loading on said launch vehicle attach structure and reducing the moment applied to said launch vehicle attach structure to maximize the mass carrying capability of said ESPA ring.

12. A payload mounting system, comprising:
a cylindrical launch vehicle attach structure comprising an even number of radial ports;
an even number of payloads; and
a cross-reaching moment transmitting structure,
wherein said payloads attach to said radial ports, and
wherein said cross-reaching moment transmitting structure attaches to said payloads to minimize the moment transmitted to said radial ports thus maximizing the launch mass capability of said cylindrical launch vehicle attach structure.

13. The payload mounting system of claim 12, wherein said launch vehicle attach structure positions at an expendable launch vehicle (EELV) secondary payload adapter (ESPA) ring.

14. The payload mounting system of claim 12, wherein each payload of said payloads attaches to a radial port of said radial ports via a first payload separation system, wherein said first payload separation system permits separation of said payload from said launch vehicle attach structure.

15. The payload mounting system of claim 14, wherein said cross-reaching moment transmitting structure comprises a third separation system that acts as an additional separation system to connect said payload.

16. The payload mounting system of claim 15, wherein said first payload separation system and said third separation system engage to release and eject said payloads radially from said launch vehicle attach structure.

17. The payload mounting system of claim 14, further comprises a second separation device, wherein second separation device attaches said moment transmitting structure to a central coupling device.

18. The payload mounting system of claim 17, wherein said payloads, said second separation device, and said central coupling device transmit loads and moments across the diameter of said launch vehicle attach structure positioned at an expendable launch vehicle (EELV) secondary payload adapter (ESPA) ring, thus relieving the moment loading on said launch vehicle attach structure and reducing the moment applied to said launch vehicle attach structure to maximize the mass carrying capability of said ESPA ring.

19. A method of providing a payload mounting system, said method comprising steps of:
providing a launch vehicle attach structure comprising radial ports;
providing payloads, said payloads connecting said radial ports;
providing a moment transmitting structure; and
attaching said moment transmitting structure to said payloads surrounding said launch vehicle attach structure for minimizing the moment transmitted to said radial ports thus maximizing the launch mass capability of said launch vehicle attach structure.

20. The method of claim 19, further comprising providing a payload separation system for permitting separation of said payloads from said launch vehicle attach structure.
